(19) United States
(12) Patent Application Publication
(10) Pub. No.: US 2020/0316735 A1
(43) Pub. Date: Oct. 8, 2020

(54) SPINDLE DEVICE AND MACHINE TOOL

(71) Applicant: FANUC CORPORATION, Yamanashi (JP)

(72) Inventor: Masahiro Murota, Yamanashi-ken (JP)

(21) Appl. No.: 16/838,491

(22) Filed: Apr. 2, 2020

(30) Foreign Application Priority Data
Apr. 5, 2019 (JP) 2019-072416

(51) Int. Cl. B23Q 1/26

(52) U.S. Cl. CPC B23Q 1/26

(57) ABSTRACT

A spindle device includes: a spindle shaft; a first housing configured to house the spindle shaft to which a gas is supplied, the first housing having a bearing that rotatably supports the spindle shaft; a motor located at an end of the spindle shaft and configured to rotate the spindle shaft; a second housing configured to house the motor, the second housing being joined to the first housing; and a duct having one end located at the bottom of a space inside the second housing and another end projecting from the second housing.

### CROSS-REFERENCE TO RELATED APPLICATION

This application is based upon and claims the benefit of priority from Japanese Patent Application No. 2019-072416 filed on Apr. 5, 2019, the contents of which are incorporated herein by reference.

### BACKGROUND OF THE INVENTION

### Field of the Invention

The present invention relates to a spindle device and a machine tool.

### Description of the Related Art

Japanese Laid-Open Patent Publication No. 2008-161950 discloses a spindle device including a rotary part and a housing with bearings for rotatably supporting the rotary part.

### SUMMARY OF THE INVENTION

However, in the spindle device disclosed in Japanese Laid-Open Patent Publication No. 2008-161950, when a cutting fluid or the like enters into the housing, a short circuit or the like may occur in an electric component provided in the housing, which causes a risk of the spindle device being broken. It is conceivable to provide a hole for discharging the cutting fluid or the like in the housing, but in this case, the cutting fluid would enter the housing through the hole.

It is therefore an object of the present invention to provide a spindle device and a machine tool capable of satisfactorily discharging a cutting fluid or the like entering a housing.

A spindle device according to one aspect of the present invention includes: a spindle shaft; a first housing configured to house the spindle shaft to which a gas is supplied, the first housing having a bearing configured to rotatably support the spindle shaft; a motor located at an end of the spindle shaft and configured to rotate the spindle shaft; a second housing configured to house the motor, the second housing being joined to the first housing; and a duct having one end located at a bottom of a space inside the second housing and another end projecting from the second housing.

A machine tool according to another aspect of the present invention includes the spindle device as described above.

According to the present invention, it is possible to provide a spindle device and a machine tool capable of satisfactorily discharging a cutting fluid or the like entering the housing of the spindle device.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a schematic diagram showing a machine tool provided with a spindle device according to an embodiment;

FIG. 2 is a sectional view showing a spindle device according to an embodiment;

FIG. 3 is a perspective view showing a spindle device according to an embodiment;

FIG. 4 is a sectional view showing an example in which the longitudinal direction of a spindle shaft extends vertically; and

FIG. 5 is a sectional view illustrating an example in which a gas flow passage is formed in a second housing.

### DESCRIPTION OF THE PREFERRED EMBODIMENTS

A spindle device and a machine tool according to the present invention will be detailed by describing a preferred embodiment with reference to the accompanying drawings.

### Embodiment

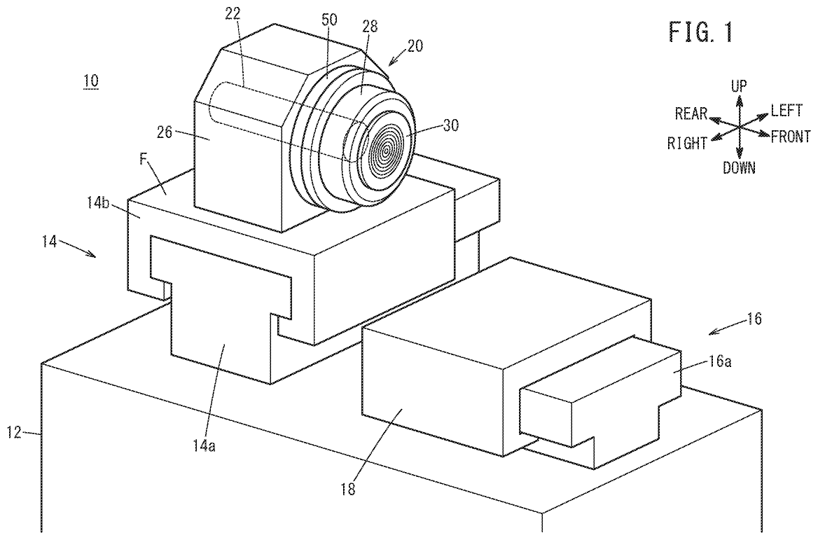

A spindle device and a machine tool according to an embodiment will be described with reference to FIGS. 1 to 3. FIG. 1 is a schematic diagram showing a machine tool provided with a spindle device according to the embodiment.

A machine tool (precision machine tool) 10 according to the present embodiment machines a workpiece with a tool. The machine tool 10 according to the present embodiment will be described exemplifying a case where static pressure bearings 60 (e.g., aero-static air bearing) capable of controlling the machining on a workpiece at nanometer level is housed in a housing 25. However, the invention should not be limited to this. Bearings other than the static pressure bearings 60, such as roiling bearings and the like, may be housed in the housing 25. In the present embodiment, a case where the machine tool 10 is a lathe machine will be described as an example, but the present invention should not be limited to this. The present invention can be applied to various machine tools 10 other than a lathe machine, such as a processing machine, a cutting machine and the like,

As shown in FIG. 1, the machine tool 10 according to the embodiment includes a base bed 12, a spindle support 14, a table support 16, a table 18 and a spindle device 20.

The longitudinal direction (axial direction) of a spindle shaft 22 provided in the spindle device 20 is defined as the front-rear direction. The direction orthogonal to the axial direction in a plane parallel to a mounting surface F on which the spindle device 20 is mounted, is defined as the left-right direction. The direction orthogonal to the mounting surface F on which the spindle device 20 is mounted and the axial direction is defined as the up-down direction. The downward direction is the direction in which gravity acts. A side of the spindle shaft 22 on which a chuck portion 30 is located is referred to as the front side. Another side of the spindle shaft 22 opposite to the side on which the chuck portion 30 is located is referred to as the rear side.

The spindle support 14 is provided on the base bed 12. The spindle device 20 is located on the spindle support 14.

The spindle support 14 includes a first slider 14a, a spindle moving table 14b, and an unillustrated first drive mechanism. The first slider 14a is mounted on the base bed 12. The longitudinal direction of the first slider 14a lies in the left-right direction. The first drive mechanism includes an unillustrated motor. The first drive mechanism further includes members such as an unillustrated ball screw. The ball screw converts the rotational force of the motor into linear motion. The first drive mechanism moves the spindle moving table 14b in the longitudinal direction of the first slider 14a. As the first drive mechanism moves the spindle moving table 14b in the longitudinal direction of the first slider 14a, the spindle device 20 provided on the spindle moving table 14b moves in the left-right direction.

The table support 16 is provided on the base bed 12. The table support 16 includes a second slider 16a and an unillustrated second drive mechanism. The longitudinal direction of the second slider 16a lies in the front-rear direction. The second drive mechanism includes an unillustrated motor. The second drive mechanism further includes members such as an unillustrated ball screw. The ball screw converts the rotational force of the motor into linear motion. The second drive mechanism moves the table 18 in the longitudinal direction of the second slider 16a. That is, the second drive mechanism moves the table 18 in the front-rear direction. In addition, the table 18 may be configured to be rotatable about an axis extending along the up-down direction serving as the rotary axis.

The spindle de vice 20 has the chuck portion 30. The chuck portion 30 holds, for example, a workpiece. The table 18 holds, for example, a tool. Note that a tool may be held by the chuck portion 30 while a workpiece may be fixed on the table 18.

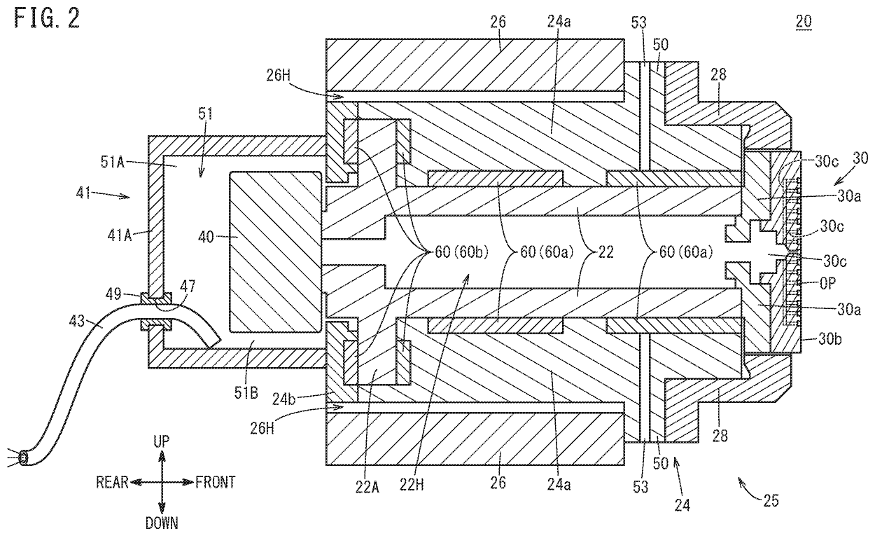

FIG. 2 is a sectional view showing the spindle device according to the present embodiment.

As shown in FIG. 2, the spindle device 20 according to the present embodiment is provided with a housing 25. The housing 25 includes a first housing 24 and a second housing 41 coupled to the first housing 24. The spindle device 20 further includes a spindle shaft 22, a motor 40, and a duct 43.

The spindle shaft 22 is housed in the first housing 24. The spindle shaft 22 is a cylindrical member. The spindle shaft 22 has, formed therein, a cylindrical through hole 22H that penetrates through the shaft in the axial direction. The first housing 24 is provided with static pressure bearings (bearings) 60 that rotatably support the spindle shaft 22 by a gas supplied to the spindle shaft 22.

The motor 40 is located at one end of the spindle shaft 22, e.g., on the rear end of the spindle shaft 22. The motor 40 is a drive source for rotating the spindle shaft 22. The front side of the motor 40 is attached to the rear side of the first housing 24 by unillustrated fixing members.

The second housing 41 houses the motor 40. The second housing 41 is joined to the rear end of the first housing 24. The second housing 41 has a first surface 41A whose normal extends in the longitudinal direction of the spindle shaft 22.

The duct 43 serves to discharge a cutting fluid or the like entering the housing 25 from the interior of the housing 25 to the outside. The duct 43 may be made of a flexible material or may be made of a solid material. Examples of the flexible material include polyvinyl chloride, but should not be limited thereto.

One end of the duct 43 is located at the bottom of a space 51 in the second housing 41. More specifically, one end of the duct 43 is located at the bottom of a space 51A between the first surface 41A of the second housing 41 and the motor 40. Note that one end of the duct 43 may not be located in the space 51A between the first surface 41A and the motor 40. For example, one end of the duct 43 may be located in a space 51B located under the motor 40. One end of the duct 43 may be fixed to the second housing 41 by an unillustrated fixing member.

Though not illustrated, a sensor, a terminal block and the like are arranged in the space 51A between the first surface 41A and the motor 40. The sensor detects the rotation of the motor 40, for example.

Power supply lines, signal lines and the like are provided in the space 51A between the first surface 41A and the motor 40, but are not shown here. The power supply lines, signal lines and the like connected to the motor 40 can supply power, signals and the like to the motor 40. The power supply lines, signal lines and the like connected to the sensor can supply power, signals and the like to the sensor. These power supply lines, signal lines and the like are provided so as to pass through unillustrated holes formed in the first surface 41A.

The other end of the duct 43 protrudes from the second housing 41. More specifically, the duct 43 protrudes from the inside of the second housing 41 to the outside via a hole 47 formed in the second housing 41. The hole 47 is positioned at a higher level than the one end (i.e., the interior end) of the duct 43, for example. A sealing member 49 for sealing a gap between the hole 47 and the duct 43 is provided therebetween.

The gas supplied to the spindle shaft 22 can flow into the space 51 in the second housing 41 through an unillustrated gap and the like. When gas is being supplied to the spindle shaft 22, the pressure inside the second housing 41 is higher than the pressure outside the second housing 41. Since the pressure inside the second housing 41 is higher than the pressure outside the second housing 41, even when the cutting fluid or the like enters the second housing 41, the cutting fluid or the like can be discharged from the housing 25 through the duct 43.

The longitudinal direction of the spindle shaft 22 a direction intersecting the vertical direction. The vertical distance (i.e., a distance in the vertical direction) between the one end of the duct 43 and the second housing 41 is smaller than the vertical distance (i.e., a distance in the vertical direction) between the motor 40 and the second housing 41. Since the vertical distance between the one end of the duct 43 and the second housing 41 is smaller than the vertical distance between the motor 40 and the second housing 41, the liquid level of the cutting fluid or the like puddling in the housing 25 can be prevented from reaching the motor 40. Therefore, it is possible to prevent a short circuit or the like from occurring in the motor 40.

The chuck portion 30 is arranged on the front side of the spindle shaft 22. The chuck portion 30 rotates with the rotation of the spindle shaft 22. The chuck portion 30 can rotate on the front surface of the first housing 24. For example, a workpiece is attached to and detached from the chuck portion 30. Although FIG. 1 shows a disc-shaped chuck portion 30, the shape of the chuck portion 30 is not limited to a disc shape. The chuck portion 30 has a base 30a fixed to the front side of the spindle shaft 22 and a suction pad (vacuum pad) 30b detachably attached to the base 30a. Openings OP are formed on the suction surface of the suction pad 30b. The base 30a and the suction pad 30b have, formed therein, communication passages 30c that establish communication between the openings OP and the through hole 22H of the spindle shaft 22. Air outside the chuck portion 30 is drawn into the through hole 22H by an unillustrated vacuum pump through the openings OP and the communication passages 30c. Thus, the workpiece is held in close contact with the suction surface.

The first housing 24 has a substantially cylindrical first housing body 24a and a rear housing lid 24b. The first housing body 24a is provided with an annular flange 50 protruding radially outward from the outer peripheral surface of the first housing body 24a. The flange 50 may be formed integrally with the first housing body 24a, or may be formed as a member separate from the first housing body 24a. When the flange 50 is formed of a member separate from the first housing body 24a, the flange 50 is fixed to the first housing body 24a by a predetermined fixture.

The rear housing lid 24b is detachably attached to the rear side of the first housing body 24a so as to cover the rear opening of the first housing body 24a. The second housing 41 is fixed to the surface (rear end surface) of the rear housing lid 24b.

The rear housing lid 24b and the first housing body 24a have, formed therein, a substantially cylindrical shaft arrangement space that penetrates therethrough along the front-rear direction. The spindle shaft 22 is arranged in this shaft arrangement space. The spindle shaft 22 arranged in the shaft arrangement space is rotatably supported by static pressure bearings 60.

The static pressure bearings 60 include thrust bearings 60a and radial bearings 60b. The thrust bearings 60a are provided on the left and right sides of the spindle shaft 22. The radial bearings 60b are arranged behind the thrust bearings 60a. The radial bearings 60b are provided on the front, and rear sides of the flange 22A of the spindle shaft 22. In the present embodiment, since the static pressure bearings 60 are used, machining on the workpiece can be controlled at nanometer level.

The spindle device 20 further includes a spindle mount 26. The spindle mount 26 is placed on the mounting surface F (FIG. 1) of the spindle moving table 14b. The spindle mount 26 has an insertion hole 26H through which the first housing 24 is inserted along the axial direction of the spindle shaft 22. The first housing 24 is inserted into the insertion hole 26H from the front side of the spindle mount 26 and fixed to the front side via the flange 50 provided on the first housing body 24a. The rear side of the first housing 24 is supported by an unillustrated support member arranged on the rear side of the spindle mount 26. In this way, the spindle mount 26 holds the first housing 24 at both ends, i.e., the front and rear sides.

The spindle device 20 is further provided with a cover member 28. The cover member 28 is provided so as to cover the front face of the flange 50, the outer peripheral surface of the first housing body 24a extending from the front face of the flange to the front, and part of the outer peripheral surface of the chuck portion 30. Here, the entire outer peripheral surface of the chuck portion 30 may be covered by the cover member 28. The cover member 28 is formed with an unillustrated coolant channel for flowing a coolant, so that the temperature of the cover member 28 can be adjusted by the coolant flowing through the coolant channel. Examples of the coolant include water, compressed air and others.

The first housing 24 has, formed therein, gas flow channels 53 for supplying gas to the spindle shaft 22. In FIG. 2, to make description simple, only two gas flow channels 53 of the multiple channels 53 formed in the first housing 24 are illustrated. In FIG. 2, illustration of flow channels for supplying gas to the gas flow channels 53 is omitted. The gas may be compressed to a predetermined pressure. Examples of the gas include air and others. As described above, the gas supplied to the spindle shaft 22 can flow into the space 51 in the second housing 41 through unillustrated gaps and the like. In other words, the second housing 41 communicates with the gas flow channels 53 via unillustrated gaps and the like. When gas is being supplied to the spindle shaft 22, the pressure inside the second housing 41 becomes higher than the pressure outside the second housing 41. Since the pressure inside the second housing 41 is higher than the pressure outside the second housing 41, even when the cutting fluid or the like enters the second housing 41, the cutting fluid or the like can pass through the duct 43 and be discharged to the outside of the housing 25. The gas supplied to the spindle shaft 22 via the as flow channels 53 is not only discharged to the outside of the housing 25 via the duct 43 but also discharged to the outside of the housing 25 through an unillustrated hole and gaps formed in the first housing 24.

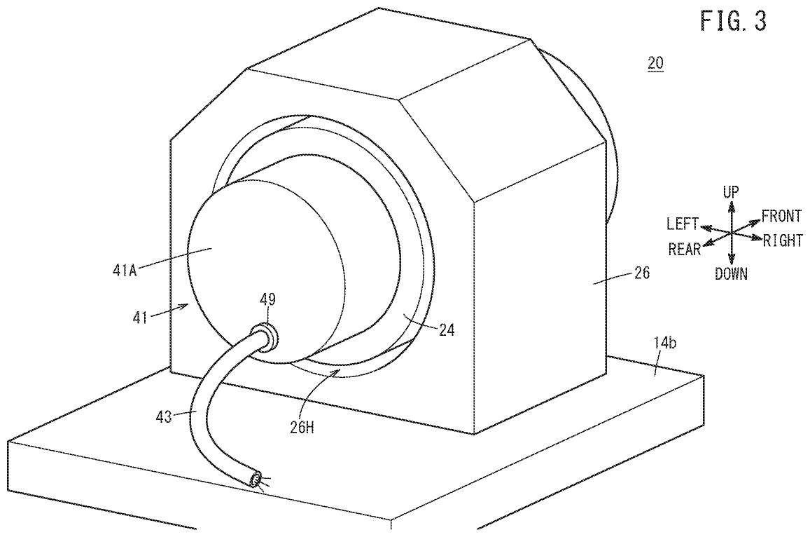

FIG. 3 is a perspective view showing the spindle device according to the present embodiment. As shown in FIG. 3, the second housing 41 is attached to the first housing 24 by unillustrated supporting members.

Thus, the spindle device 20 according to the present embodiment is configured.

As described above, according to the present embodiment, the duct 43 having one end located at the bottom of the space 51 in the second housing 41 and the other end protruding from the second housing 41 is provided. When gas is being supplied to the spindle shaft 22, a higher pressure is applied to the space 51 in the second housing 41 than to the outside of the second housing 41. Therefore, according to the present embodiment, the cutting fluid or the that enters the housing 25 can be appropriately discharged through the duct 43. Therefore, according to the present embodiment, it is possible to prevent a short circuit or the like from occurring in the electrical components provided in the housing 25, and hence it is possible to provide the spindle device 20 and the machine tool 10 that are highly reliable.

### MODIFIED EXAMPLES

Though the preferred embodiment of the present invention has been described above, the present invention is not limited to the above embodiment, and various modifications can be made without departing from the gist of the present invention.

For example, the above embodiment has been explained by referring to a case where the bearings housed in the housing 25 are static pressure bearings 60, but the present invention should not be limited to this. As mentioned before, the bearings housed in the housing 25 may be rolling bearings or the like. Even in the housing 25 that accommodates therein bearings other than the static pressure bearings 60, gas can be supplied to the spindle shaft 22 and the like (e.g., air purge).

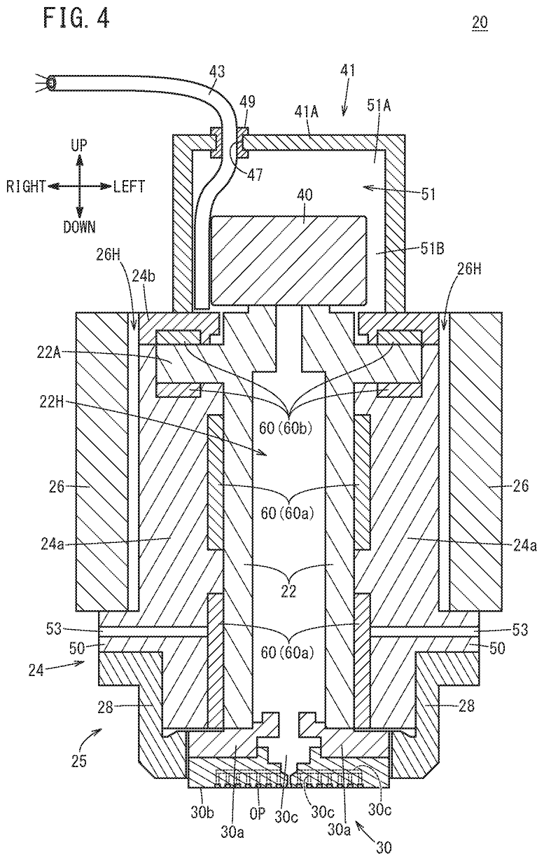

Also, the above embodiment has been explained by referring to a case where the longitudinal direction of the spindle shaft 22 intersects the vertical direction, but the present invention should not be limited to this. The spindle shaft 22 may be arranged so that its longitudinal direction extends in the vertical direction. FIG. 4 is a sectional view showing an example where the longitudinal direction of the spindle shaft extends along the vertical direction. In the example shown in FIG. 4, the spindle shaft 22 is set so that its longitudinal direction extends in the vertical direction. In the example shown in FIG. 4, the interior end (i.e., the one end) of the duct 43 is positioned at a level lower than the lower surface of the motor 40. Also in this configuration, it is possible to appropriately discharge the cutting fluid or the like that enters the housing 25 by use of the duct 43. Thus, also in this configuration, it is possible to prevent a short circuit or the like from occurring in the electrical components provided in the housing 25, and hence it is possible to provide the spindle device 20 and the machine tool 10 that are highly reliable.

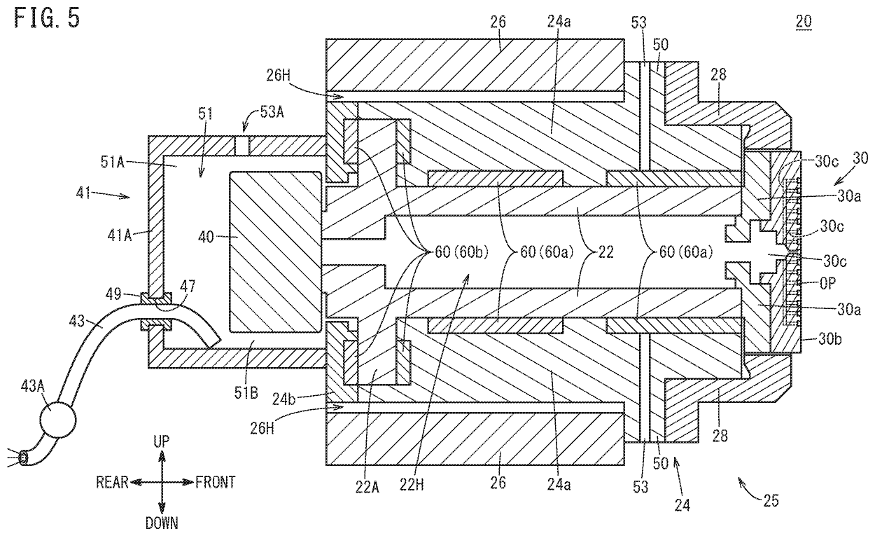

Further, the above embodiment has been described by referring to a case where the gas flow channels 53 are formed in the first housing 24, but the present invention should not be limited to this. FIG. 5 is a sectional view showing an example in which a gas flow channel is formed in the second housing. In the example shown in FIG. 5, a gas flow channel 53A is formed in the second housing 41. In FIG. 5, the illustration of a duct for supplying gas to the gas flow channel 53A is omitted. In the example shown in FIG. 5, the duct 43 is provided with a flow rate adjustment valve (throttle valve) 43A. As in the example shown in FIG. 5, also when the gas is supplied to the second housing 41, the pressure in the housing 25 can be increased, so that the gas can be supplied to the spindle shaft 22 and the like. Moreover, in the example shown in FIG. 5, since the flow rate adjustment valve 43A is provided, the pressure in the housing 25 can be sufficiently increased by reducing the gas flow rate in the flow rate adjustment valve 43A. Also in the example shown in FIG. 5, it is possible to prevent foreign material from entering the housing 25.

The above embodiments are summarized as follows.

The spindle device (20) includes: a spindle shaft (22); a first housing (24) configured to house the spindle shaft to which a gas is supplied, the first housing having a bearing (60) configured to rotatably support the spindle shaft; a motor (40) located at an end of the spindle shaft and configured to rotate the spindle shaft; a second housing (41) configured to house the motor, the second housing being joined to the first housing; and a duct (43) having one end located at the bottom of a space (51) inside the second housing and another end projecting from the second housing.

According to the above configuration, a duct having one end located a the bottom of the space in the second housing and the other end projecting from the second housing is provided. When the gas is being supplied to the spindle shaft, a higher pressure is applied to the space inside the second housing than to the outside of the second housing. For this reason, this configuration makes it possible to discharge the cutting fluid and the like entering the housing through the duct satisfactorily. Thus, according to the above configuration, it is possible to prevent a short circuit or the like from occurring in electrical components provided inside the housing, and hence provide a highly reliable spindle device and a highly reliable machine tool.

The bearing may be a static pressure bearing configured to rotatably support the spindle shaft by supply of a gas to the spindle shaft.

The duct may be configured to project from the inside to the outside of the second housing through a hole (47) formed in the second housing, and the hole may be positioned at a level higher than the one end of the duct.

The duct may be configured to project from the inside to the outside of the second housing through a hole formed in the second housing, and a sealing member (49) configured to seal a gap between the hole and the duct may be further provided. According to the above configuration, when the gas is being supplied to the spindle shaft, the pressure in the space inside the second housing can be kept higher than the pressure outside the second housing while it is possible to prevent the cutting fluid or the like from entering the housing through the gap between the hole and the duct.

The second housing may include a first surface (41A) whose normal extends in the longitudinal direction of the spindle shaft, a space (51A) may be formed between the first surface and the motor, and the one end of the duct may be arranged in the space between the first surface and the motor.

The longitudinal direction of the spindle shaft may be a direction intersecting the vertical direction, and the distance in the vertical direction between the one end of the duct and the second housing may be smaller than the distance in the vertical direction between the motor and the second housing. According to the above configuration, it is possible to prevent the liquid level of the cutting fluid or the like entering the housing from reaching the motor, and hence prevent a short circuit or the like from occurring in the motor.

The longitudinal direction of the spindle shaft may be oriented in the vertical direction, and the one end of the duct may be positioned at a level lower than the lower surface of the motor.

A machine tool (10) includes the above spindle device.

What is claimed is:

1. A spindle device comprising:
a spindle shaft;
a first housing configured to house the spindle shaft to which a gas is supplied, the first housing having a bearing configured to rotatably support the spindle shaft;
a motor located at an end of the spindle shaft and configured to rotate the spindle shaft;
a second housing configured to house the motor, the second housing being joined to the first housing; and
a duct having one end located at a bottom of a space inside the second housing and another end projecting from the second housing.

2. The spindle device according to claim 1, wherein the bearing is a static pressure bearing configured to rotatably support the spindle shaft by supply of a gas to the spindle shaft.

3. The spindle device according to claim 1, wherein:
the duct is configured to project from inside to outside of the second housing through a hole formed in the second housing; and
the hole is positioned at a level higher than the one end of the duct.

4. The spindle device according to claim 1, wherein:
the duct is configured to project from inside to outside of the second housing through a hole formed in the second housing; and
a sealing member configured to seal a gap between the hole and the duct is further provided.

5. The spindle device according to claim 1, wherein:
the second housing includes a first surface whose normal extends in a longitudinal direction of the spindle shaft;
a space is formed between the first surface and the motor; and
the one end of the duct is arranged in the space between the first surface and the motor.

6. The spindle device according to claim 1, wherein:
a longitudinal direction of the spindle shaft a direction intersecting a vertical direction; and
a distance in the vertical direction between the one end of the duct and the second housing is smaller than a distance in the vertical direction between the motor and the second housing.

7. The spindle device according to claim 1, wherein
a longitudinal direction of the spindle shaft is oriented in a vertical direction; and
the one end of the duct is positioned at a level lower than a lower surface of the motor.

8. A machine tool comprising the spindle device according to claim 1.
